(19) United States
(12) Patent Application Publication
(10) Pub. No.: US 2009/0071286 A1
(43) Pub. Date: Mar. 19, 2009

(54) SPRING APPARATUS AND ACCELERATOR PEDAL APPARATUS

(75) Inventors: Masato Ueno, Kariya-city (JP); Haruhiko Suzuki, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/195,640

(22) Filed: Aug. 21, 2008

(30) Foreign Application Priority Data
Sep. 14, 2007 (JP) 2007-239547

(51) Int. Cl. G05G 1/30; F16F 3/04

(52) U.S. Cl. 74/513; 267/168

(57) ABSTRACT

A spring apparatus includes a double coil spring and an elastically deformable damper made of resin. The double coil spring includes an outer coil spring and an inner coil spring. The damper has at least one ring portion. The damper is arranged such that at least a part of the damper is in contact with the outer coil spring and the inner coil spring. A spring line of one of the outer coil spring and the inner coil spring passes through the ring portion, so that the ring portion is caught in the one of the outer coil spring and the inner coil spring and the damper is held between the outer coil spring and the inner coil spring.

### CROSS REFERENCE TO RELATED APPLICATION

This application is based on and incorporates herein by reference Japanese Patent Application No. 2007-239547 filed on Sep. 14, 2007.

### BACKGROUND OF THE INVENTION

1. Field of the Invention

The present invention relates to a spring apparatus in which vibration of a double coil spring is controlled by a damper, and to an accelerator pedal apparatus having the spring apparatus.

2. Description of Related Art

Not only in a spring apparatus having a double coil spring, but in a spring apparatus having a coil spring, when a load applied to the coil spring is rapidly relieved, or due to an impact made from the outside, the coil spring vibrates and thereby generates an abnormal noise (spring noise). In the spring apparatus using the double coil spring, a damper made of elastic resin is placed between an outer coil spring and inner coil spring and accordingly the damper is constantly in contact with the outer coil spring and the inner coil spring. As a result, the spring noise is limited (see, e.g., JP2005-231538A corresponding to US2005/0183535A1).

Conventional technologies are described below with reference to FIGS. 6A to 7C (numerals, which are common to embodiments described hereinafter, are used in FIGS. 6A to 7C). As shown in FIG. 6A, a flat plate portion of a thin damper 17 having a flat plate shape, which is formed in a cross shape or in a rectangular shape, is placed between an outer coil spring 11 and an inner coil springs 12. As shown in FIG. 7A, a thickness part of a cylindrical portion of a damper 17 having a cylindrical shape is placed between an outer coil spring 11 and an inner coil spring 12.

However, the technology to use the damper 17, which is formed in a cross or rectangular shape, may reduce an effect of limiting the spring noise because, as shown in FIG. 6B, a positional shift of the damper 17 is caused due to expansion and contraction of a double coil spring. Furthermore, when a shift amount of the damper 17 becomes large, the damper 17 may be separated from between the double coil spring. As indicated by an arrow X in FIG. 6C, while the double coil spring is in operation, an end portion of the damper 17 (end of the flat plate portion) interferes with the outer coil spring 11 or the inner coil spring 12. Accordingly, the damper 17 is flipped, and as a result, the damper 17 may generate an abnormal noise.

On the other hand, the technology to use the damper 17 having a cylindrical shape may not limit the spring noise when the damper 17 is not in contact with one of the double coil spring because of a diameter size or thickness of the damper 17. More specifically, due to a thermal expansion difference between the double coil spring and the damper 17 or reduction in diameter of the damper 17 caused by its secular changes, the damper 17 may not be in contact with one of the double coil spring. When a diameter of the damper 17 is expanded in a clearance of the double coil spring, as shown in FIG. 7B, the damper 17 and the inner coil spring 12 are not in contact with each other, and accordingly the spring noise of the inner coil spring 12 cannot be limited. Conversely, when the diameter of the damper 17 is contracted in the clearance of the double coil spring, as shown in FIG. 7C, the damper 17 and the outer coil spring 11 are not in contact with each other, and accordingly the spring noise of the outer coil spring 11 cannot be limited. Moreover, when the damper 17 is not in contact with one spring of the double coil spring, the damper 17 is no longer held by the double coil spring. As a result, as shown in FIG. 78, the damper 17 falls down by gravity.

More specifically, in the accelerator pedal apparatus employing the above technologies (the spring apparatus having the damper 17 that is formed in a cross or rectangular shape or the spring apparatus having the damper 17 that is formed in a cylindrical shape), the effect of limiting the spring noise of the double coil spring may be reduced, or the accelerator pedal apparatus may have no effect of limiting the noise, for the reasons mentioned above.

### SUMMARY OF THE INVENTION

The present invention addresses the above disadvantages. Thus, it is an objective of the present invention to provide a spring apparatus and an accelerator pedal apparatus, which reliably limit a spring noise of a double coil spring over a long period of time.

To achieve the objective of the present invention, there is provided a spring apparatus including a double coil spring and an elastically deformable damper. The double coil spring includes an outer coil spring and an inner coil spring. The damper is made of resin. The damper has at least one ring portion. The damper is arranged such that at least a part of the damper is in contact with the outer coil spring and the inner coil spring. A spring line of one of the outer coil spring and the inner coil spring passes through the ring portion, so that the ring portion is caught in the one of the outer coil spring and the inner coil spring and the damper is held between the outer coil spring and the inner coil spring.

To achieve the objective of the present invention, there is also provided an accelerator pedal apparatus including a supporting member, an accelerator pedal, and the spring apparatus. The accelerator pedal is rotatably supported by the supporting member and is depressed by external force. The spring apparatus urges the accelerator pedal in a direction in which the accelerator pedal is returned against the external force.

### BRIEF DESCRIPTION OF THE DRAWINGS

The invention, together with additional objectives, features and advantages thereof, will be best understood from the following description, the appended claims and the accompanying drawings in which:

FIG. 1A is a diagram illustrating a spring apparatus according to a first embodiment of the invention;

FIG. 1B is a diagram illustrating the spring apparatus according to the first embodiment;

FIG. 1C is a diagram illustrating the spring apparatus according to the first embodiment;

FIG. 2A is a diagram illustrating a damper according to the first embodiment;

FIG. 2B is a diagram illustrating the damper according to the first embodiment;

FIG. 2C is a diagram illustrating the damper according to the first embodiment;

FIG. 3 is a diagram illustrating an internal configuration of an accelerator pedal apparatus according to the first embodiment;

FIG. 4A is a diagram illustrating a spring apparatus according to a second embodiment of the invention;

FIG. 4B is a diagram illustrating the spring apparatus according to the second embodiment;

FIG. 4C is a diagram illustrating the spring apparatus according to the second embodiment;

FIG. 4D is a diagram illustrating the spring apparatus according to the second embodiment;

FIG. 5A is a diagram illustrating a spring apparatus according to a third embodiment of the invention;

FIG. 5B is a diagram illustrating the spring apparatus according to the third embodiment;

FIG. 6A is a diagram illustrating a first previously proposed spring apparatus;

FIG. 6B is a diagram illustrating the first previously proposed spring apparatus;

FIG. 6C is a diagram illustrating the first previously proposed spring apparatus;

FIG. 7A is a diagram illustrating a second previously proposed spring apparatus;

FIG. 7B is a diagram illustrating the second previously proposed spring apparatus; and

FIG. 7C is a diagram illustrating the second previously proposed spring apparatus.

### DETAILED DESCRIPTION OF THE INVENTION

A spring apparatus according to embodiments of the invention is used, for example, as a return spring in an accelerator pedal apparatus that urges an accelerator pedal in a direction in which the accelerator pedal returns against pedal force. The spring apparatus includes a double coil spring having an outer coil spring and an inner coil spring, and an elastically deformable damper made of resin. At least a part of the damper is in contact with both the outer coil spring and the inner coil spring. The damper is provided with one or more ring portions. A spring line of the outer coil spring or the inner coil spring passes through the ring portion, and thereby the ring portion is caught in the outer coil spring or the inner coil spring. As a result, the damper is held between the outer coil spring and the inner coil spring.

### First Embodiment

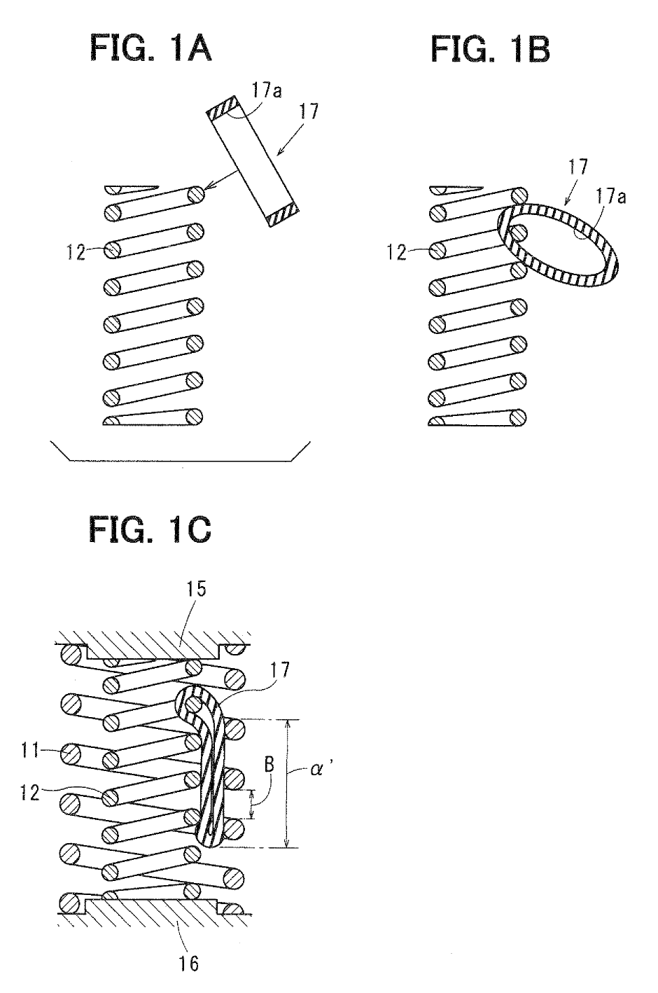

An accelerator pedal apparatus having a spring apparatus, to which the invention is applied, is described below with reference to FIGS. 1A to 3. The accelerator pedal apparatus controls an operational state of an engine for vehicle traveling according to pedal force applied to a accelerator pedal 1 by a driver. In a first embodiment of the invention, a throttle-by-wire method is employed, and the accelerator pedal 1 is not mechanically connected with a throttle apparatus of a vehicle. Instead, in the accelerator pedal apparatus, a rotation angle of the accelerator pedal 1 is detected by a rotational angle sensor 2, and then a signal indicating the detection result is outputted to an electronic control unit (ECU: engine control unit) of the engine of the vehicle. Accordingly, the ECU controls a throttle apparatus based on the rotation angle of the accelerator pedal 1 obtained from the output signal from the rotational angle sensor 2.

An example of the accelerator pedal apparatus is explained specifically. The accelerator pedal apparatus is installed under the driver's foot, and is operated by pedal force of the driver's foot. The accelerator pedal apparatus includes the accelerator pedal 1, which is operated by the vehicle drivers pedal force, the rotational angle sensor 2, which detects a rotational angle of the accelerator pedal 1, a housing 3, which is fixed to the vehicle under the driver's foot and rotatably supports the accelerator pedal 1, and a spring apparatus 4, which urges the accelerator pedal 1 in a direction of returning the accelerator pedal 1 against the pedal force.

The pedal force is applied to the accelerator pedal 1 by the driver's foot. The accelerator pedal 1 includes a pedal root part 5, which is rotatably supported with respect to the housing 3, a pedal 6, which is stepped on by the driver's foot, and a pedal rod (arm) 7, which connects the pedal root part 5 and the pedal 6. Even when there is no pedal force of the accelerator pedal 1 and the force in the direction in which the accelerator pedal 1 returns is applied by the spring apparatus 41 the accelerator pedal 1 is stopped by a stopper 8 at a predetermined position (initial position of the accelerator pedal 1). The accelerator pedal 1 is returned to the initial position and stops when the accelerator pedal 1 is not operated.

The rotational angle sensor 2 is a widely known sensor, which electrically detects a relative rotation amount between a fixed member (e.g., housing 3) and a rotation member (e.g., rotor), and the sensor output of the sensor 2 is given to the ECU, which controls the engine.

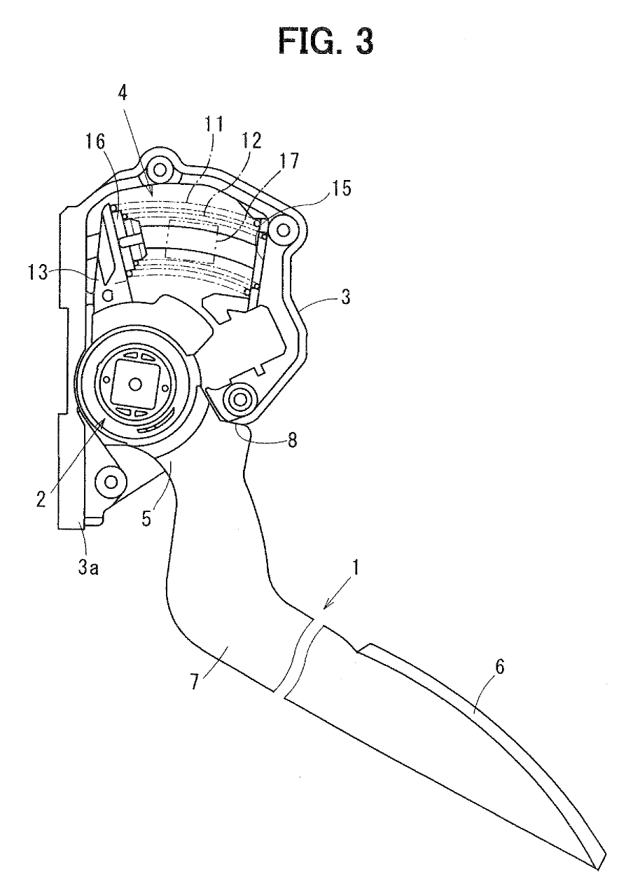

The housing 3 accommodates the pedal root part 5 of the accelerator pedal 1, the rotational angle sensor 2, the spring apparatus 4, and the like. The housing 3 is formed, for example, of synthetic resin (e.g., polyacetal or polyamide). A chassis attaching portion (e.g., flange) 3a is integrally formed on the housing 3. By fixing the chassis attaching portion 3a to the vehicle using a fastening member such as a screw, the accelerator pedal apparatus is fixed to the vehicle. In addition, the housing 3 may be a single component, or a housing main body (a part covering a main part: FIG. 3 shows this type) and a cover may be joined by the housing 3.

The spring apparatus 4 is a return spring, which returns the accelerator pedal 1 to its initial position. The spring apparatus 4 has a double coil spring including a metal outer coil spring 11 whose surface is coated with a film (e.g., resin) and a metal inner coil spring 12 which is disposed inside the outer coil spring 11 and whose surface is coated with a film (e.g., resin). The spring apparatus 4 is configured such that, even if one coil spring should be damaged, the accelerator pedal 1 is returned to its initial position by the other coil spring.

Both the outer coil spring 11 and the inner coil spring 12 are cylindrical compression coil springs having constant diameters and constant pitches in their respective axial directions. The outer coil spring 11 has a larger diameter than the inner coil spring 12 and is wound reversely to the inner coil spring 12. The outer coil spring 11 is disposed in the housing 3 with the inner coil spring 12 arranged inside the outer coil spring 11 (in a state of a double coil spring). More specifically, a small clearance is formed between the outer coil spring 11 and the inner coil springs 12 for preventing the outer coil spring 11 and the inner coil springs 12 from interfering with workings of the accelerator pedal apparatus.

The outer coil spring 11 and the inner coil spring 12 of the spring apparatus 4 are arranged not to be positionally shifted from a normal attachment position when attached to the accelerator pedal apparatus. More specifically, a fixed spring seat 15, which is formed in a dish shape having a step, is provided on a portion of the housing 3 that the double coil spring engages. The fixed spring seat 15 includes an outer spring seat having a circular recess shape that corresponds to the peripheral diameter of the outer coil spring 11 and an inner spring seat having a circular recess shape that corresponds to the peripheral diameter of the inner coil spring 12. On the other hand, a movable spring seat 16, which is formed in a projection shape having a step, is provided on a portion of a lever 13 that the double coil spring engages. The movable spring seat 16 includes an outer spring seat having a circular projection shape that corresponds to an inner diameter of the outer coil spring 11 and an inner spring seat having a circular projection shape that corresponds to an inner diameter of the inner coil spring 12. In addition, the shapes of the fixed spring seat 15 and the movable spring seat 16 are exemplary, and they may have other shapes.

The double coil spring vibrates and thereby a spring noise is generated in the accelerator pedal apparatus when the pedal force of the accelerator pedal 1 is relieved rapidly or an impact is given on the apparatus from the outside. As shown in FIGS. 1A to 1C, the spring apparatus 4 has an elastically deformable damper 17 made of resin for limiting the spring noise, in addition to the above double coil spring. The damper 17 is in contact with both the outer coil spring 11 and the inner coil spring 12 with at least a part of the damper 17 being put between the outer coil spring 11 and inner coil spring 12. The damper 17 includes at least one ring portion 17a, which is a connected ring without discontinuity. A spring line (wire rod) of one of the outer coil spring 11 and the inner coil spring 12 passes through the ring portion 17a, and accordingly the ring portion 17a is hooked to one of the outer coil spring 11 and the inner coil spring 12. As a result, the damper 17 is held between the outer coil spring 11 and the inner coil spring 12.

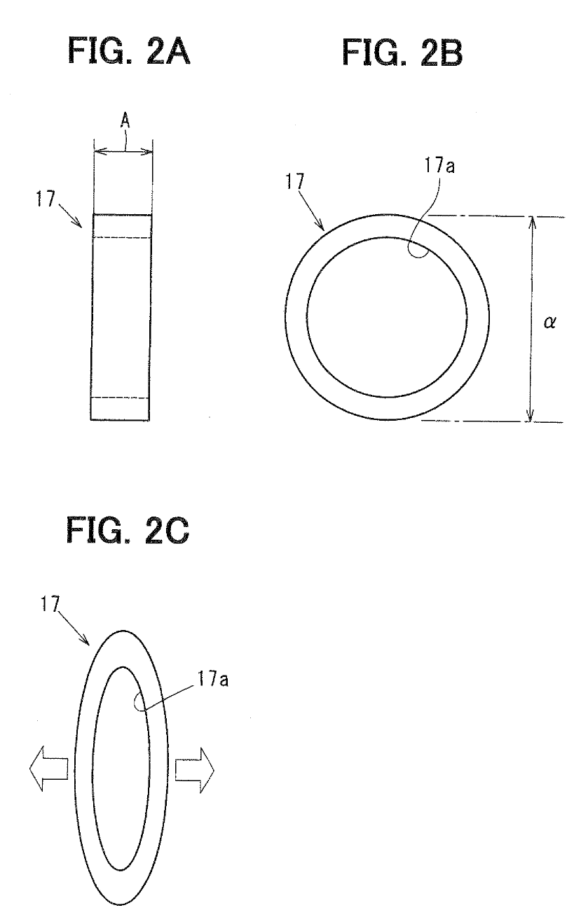

More specifically, an example of the damper 17 is explained below. As shown in FIG. 2B, the damper 17 itself of the first embodiment is one ring portion 17a. The damper 17 is formed in a short cylindrical shape in its axial direction from an elastically deformable resin material (material which does not lose elastic force over a long period of time and is excellent in durability) such as rubber. As shown in FIG. 2B, the damper 17 has a round shape in an unloaded condition. A side surface (cylindrical side surface) of the damper 17 is placed between the outer coil spring 11 and the inner coil spring 12 and thereby the round shape of the damper 17 is crushed, with the damper 17 engaging the double coil spring. As shown in FIG. 2C, the side surface of the damper 17 is in forcible contact with both the outer coil spring 11 and the inner coil spring 12 by restitution force (see a white arrow in FIG. 2C) of the damper 17.

The damper 17 is held between the outer coil spring 11 and the inner coil spring 12, and as shown in FIG. 1C, a diameter α of the damper 17 is set such that the side surface of the damper 17 is reliably in contact with “one or more places of the outer coil spring 11” and “one or more places of the inner coil spring 12” with the round shape of the damper 17 crushed. To show a concrete example, as shown in FIG. 1C, provided that a length of a part of the damper 17 held between the outer coil spring 11 and the inner coil springs 12 is α′ and that a maximum gap between lines of the outer coil spring 11 and the inner coil springs 12 (one of the outer coil spring 11 and the inner coil spring 12 having a larger pitch since both of them are even pitch coils in the first embodiment), in an initial set state (state where the pedal force is not applied to the accelerator pedal 1) in which the double coil spring is attached to the accelerator pedal apparatus (object for the attachment), is B, a relation of α′>B is satisfied.

A width A of the damper 17 is set such that the damper 17 reliably does not fall out of “a gap between lines of the outer coil spring 11” or “a gap between lines of the inner coil spring 12” in the state where the damper 17 is held between the outer coil spring 11 and the inner coil spring 12. More specifically, provided that a width of the damper 17 in a direction perpendicular to a ring of the ring portion 17a of the damper 17 is A and that a maximum gap between lines of the outer coil spring 11 and the inner coil springs 12 in the initial set state in which the double coil spring is attached to the accelerator pedal apparatus is B, a relation of A>B is satisfied.

Next, the attachment of the damper 17 to the double coil spring is explained below. As described above, a spring line of one of the outer coil spring 11 and the inner coil spring 12 passes through the inside of the ring portion 17a of the damper 17, and thereby the ring portion 17a is caught in one of the outer coil spring 11 and the inner coil spring 12. As a result, the damper 17 is held between the outer coil spring 11 and the inner coil spring 12. Since the damper 17 itself is the ring portion 17a in the first embodiment, a spring line of one of the outer coil spring 11 or the inner coil spring 12 passes through the damper 17. More specifically, the first embodiment illustrates that the damper 17 is hooked on the spring line of the inner coil spring 12.

First, as shown in FIG. 1A, a free end of the inner coil spring 12 is put into the ring of the damper 17 such that the damper 17 bridges one or more coil pitches of the inner coil spring 12. Accordingly, the damper 17 is caught in the spring line of the inner coil spring 12. Next, as shown in FIG. 1B, the damper 17, which is caught in the spring line of the inner coil spring 12, is pulled out to the outside of the inner coil spring 12. Then, the outer coil spring 11 is attached to cover the inner coil spring 12 from its upper side. By the above procedure of attachment, the spring line of the inner coil spring 12 passes through the inside of the damper 17. Accordingly, the ring portion 17a is caught in the inner coil spring 12, and the damper 17 is held between the outer coil spring 11 and the inner coil spring 12. As shown in FIG. 1C, the double coil spring is attached to the inside of the housing 3 of an accelerator pedal apparatus (more specifically between the fixed spring seat 15 and the movable spring seat 16) with the above state maintained. In addition, shapes of the spring seats in FIG. 1C are for the purpose of illustration, and are different from their actual shapes.

### (Advantageous Effect of First Embodiment)

In the accelerator pedal apparatus of the first embodiment, the damper 17 is held between the outer coil spring 11 and the inner coil spring 12. Thus, the damper 17 is always in contact with both the outer coil spring 11 and the inner coil spring 12 due to the restitution force of the damper 17. Accordingly, even when the driver rapidly relieves the pedal force of the accelerator pedal 1 or vibration (e.g., vehicle vibration) from the outside is caused in the accelerator pedal apparatus, the spring noise of the double coil spring is reliably limited. Particularly because the damper 17 is constantly pressed against both the outer coil spring 11 and the inner coil spring 12 due to the restitution force of the damper 17, damping force for the outer coil spring 11 and the inner coil spring 12 is great, and accordingly there is an advantage of a great effect of limiting the spring noise.

Because the damper 17 is caught in the inner coil spring 12 through the ring portion 17a of the damper 17 itself, and the damper 17 is held between the outer coil spring 11 and the inner coil spring 12, the positional shift of the damper 17 is limited even when the double coil spring repeats expansion and contraction. As a result, the damper 17 is in contact with both the outer coil spring 11 and the inner coil spring 12 over a long period of time. In the above manner, because the positional shift of the damper 17 is prevented, and the damper 17 is in contact with both the outer coil spring 11 and the inner coil spring 12 over a long period of time, the spring noise of the double coil spring is reliably limited over a long period of time.

The damper 17 itself of the first embodiment is one ring portion 17a. Accordingly, an end (end of a flat plate part) of the damper 17 that is flipped by the double coil spring does not exist, and thus the damper 17 does not generate an abnormal noise as a result of the flip of The damper 17 while the double coil spring is in operation. Moreover, since the damper 17 itself is one ring portion 17a, and a shape of the damper 17 is simple, the damper 17 may be produced even by cutting a rubber tube at predetermined intervals (width A), for example. As a result, the manufacturing cost of the damper 17 is held down, and the cost of the accelerator pedal apparatus is held down. Therefore, the accelerator pedal apparatus, which limits the spring noise reliably over a long period of time, is cheaply offered.

Furthermore, in the first embodiment, “the width A of the damper 17 in a direction perpendicular to the ring of the ring portion 17a of the damper 17” is larger than “the maximum gap B between lines of the outer coil spring 11 and the inner coil springs 12 in the initial set state in which the double coil spring is attached to the accelerator pedal apparatus” (A>B). Accordingly, the entering of the damper 17 between the lines of the outer coil spring 11 and the inner coil spring 12 is limited. Thus, decrease in contact between the damper 17 and the double coil spring due to the entering of the damper 17 between the lines of the outer coil spring 11 and the inner coil spring 12 is limited. Therefore, the spring noise of the double coil spring is reliably limited over a long period of time.

### Second Embodiment

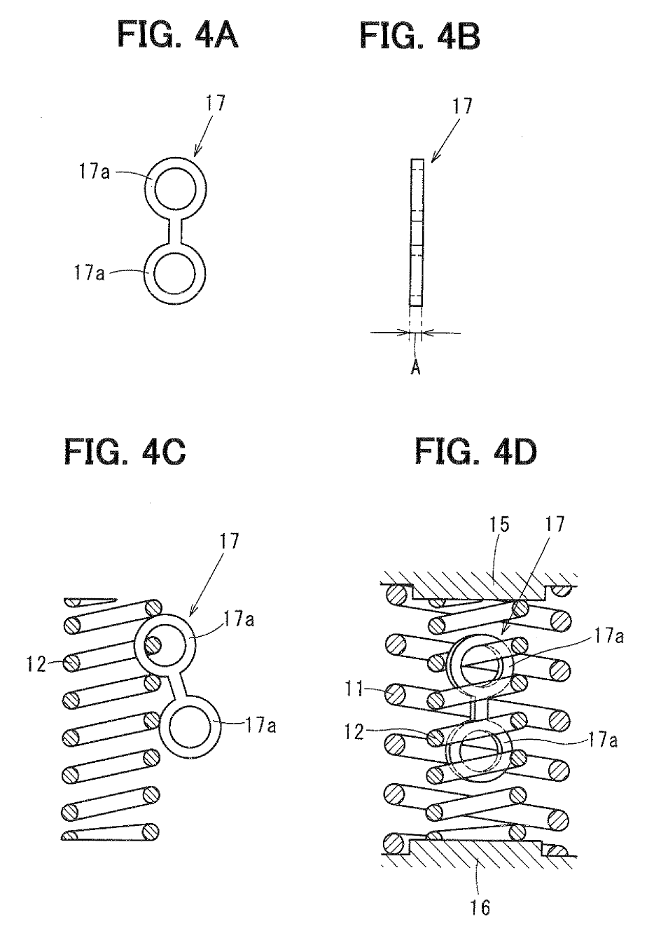

A second embodiment of the invention is described below with reference to FIGS. 4A to 4D. In addition, the same numerals in the following embodiments as the first embodiment indicate the same corresponding functional components as those in the first embodiment. As shown in FIGS. 4A, 4B, a damper 17 of the second embodiment has ring portions 17a respectively at both its ends. The damper 17 of the second embodiment is formed such that “a width A of the damper 17 in a direction perpendicular to the ring of the ring portion 17a of the damper 17” is small. The above width A is set such that a relation of A≧C is satisfied so that the damper 17 is reliably in contact with both the outer coil spring 11 and the inner coil spring 12, provided that a clearance between an outer coil spring 11 and an inner coil spring 12 in their radial direction is C.

Attachment of the damper 17 of the second embodiment is described below. First, as shown in FIG. 4C, a free end of the inner coil spring 12 is put into a ring of one ring portion 17a, such that the ring portion 17a bridges one or more coil pitches of the inner coil spring 12. When an inner diameter of the ring portion 17a is smaller than an outer diameter of a spring line of the inner coil spring 12, The ring portion 17a is expanded so that the free end of the inner coil spring 12 is put into the ring of the ring portion 17a. Accordingly, the spring line passes through one ring portion 17a and thereby the damper 17 is hooked to the spring line of the inner coil spring 12. Next, the damper 17, which is hooked to the spring line of the inner coil spring 12, is pulled out to the outside of the inner coil spring 12. Then, the outer coil spring 11 is attached to cover the inner coil spring 12 from its upper side.

By the above procedure of attachment, the spring line of the inner coil spring 12 passes through one ring portion 17a. Accordingly, the ring portion 17a is caught in the inner coil spring 12, and the damper 17 is held between the outer coil spring 11 and the inner coil spring 12. Then, with the above state maintained, as shown in FIG. 4D, the double coil spring is attached to the housing 3 of the accelerator pedal apparatus.

By means of the damper 17 of the second embodiment as well, the damper 17 is caught in the inner coil spring 12 through one ring portion 17a and the damper 17 is held between the outer coil spring 11 and the inner coil spring 12. Therefore, the positional shift of the damper 17 is prevented even though the double coil spring repeats expansion and contraction. Accordingly, the damper 17 is in contact with both the outer coil spring 11 and the inner coil spring 12 over a long period of time, and thus the spring noise of the double coil spring is reliably limited.

### Third Embodiment

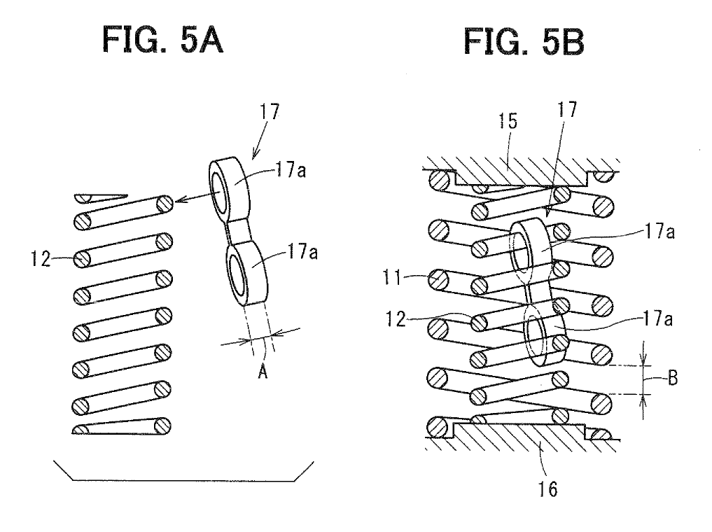

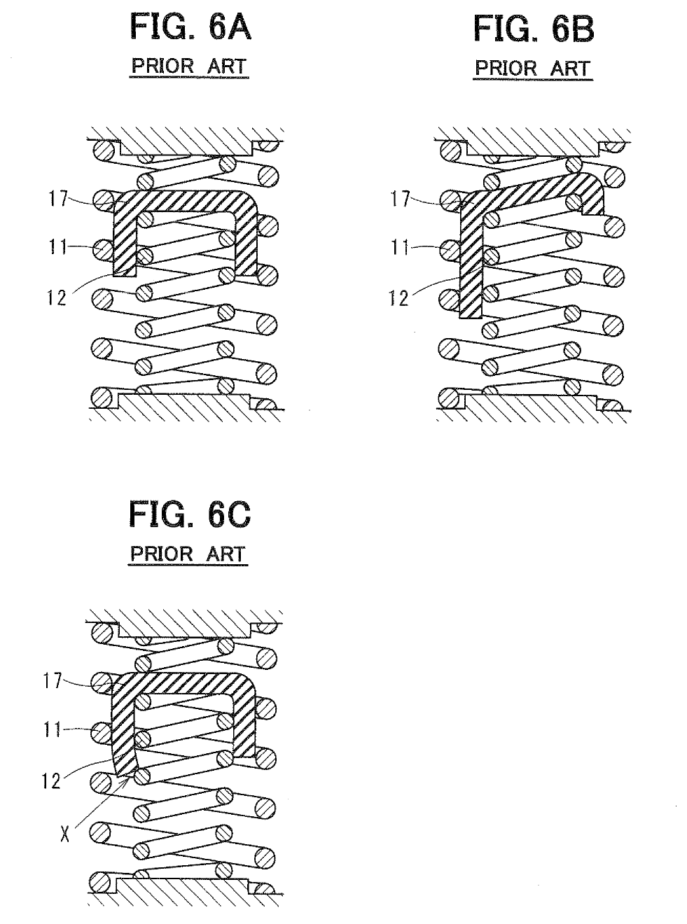

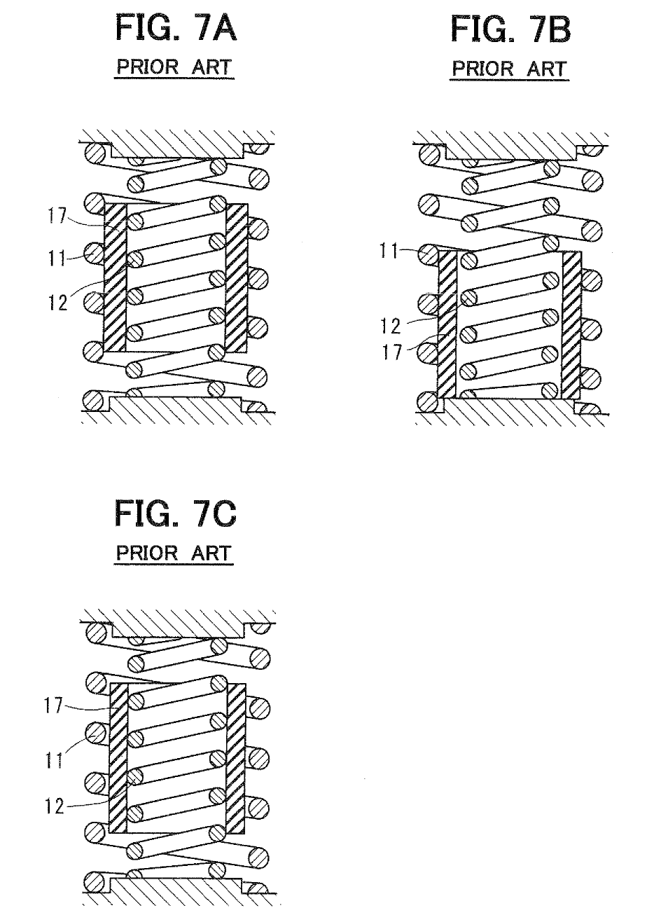

A third embodiment of the invention is described below with reference to FIGS. 5A, 5B. In the third embodiment, similar to the second embodiment, a damper 17 is provided with ring portions 17a respectively at both its ends. However, the damper 17 of the third embodiment is formed such that “a width A of the damper 17 in a direction perpendicular to the ring of the ring portion 17a of the damper 17” is larger than that of the second embodiment. Similar to the first embodiment, the width A is larger than “a maximum gap B between lines of the outer coil spring 11 and the inner coil springs 12 in the initial set state in which the double coil spring is attached to the accelerator pedal apparatus” (A>B).

The procedures of the attachment are similar to those of the second embodiment. However, because the width A of the damper 17 is thinly formed in the second embodiment, when covering the inner coil spring 12 with the outer coil spring 11 from its upper side, the ring of the ring portion 17a faces a radial direction (side face direction of the double coil spring) of the double coil spring (see FIG. 4D) if the double coil spring is seen from its side surface. Since the width A is thick in the third embodiment, when covering the inner coil spring 12 with the outer coil spring 11 from its upper side, the ring of the ring portion 17a is crushed between the outer coil spring 11 and the inner coil spring 12, which is similar to the first embodiment. Accordingly, as shown in FIG. 5B, a side surface (belt part) of the ring portion 17a faces the radial direction of the double coil spring.

By means of the damper 17 of the third embodiment as well, the damper 17 is caught in the inner coil spring 12 through one ring portion 17a and the damper 17 is held between the outer coil spring 11 and the inner coil spring 12. Therefore, the positional shift of the damper 17 is prevented even though the double coil spring repeats expansion and contraction. Accordingly, the damper 17 is in contact with both the outer coil spring 11 and the inner coil spring 12 over a long period of time, and thus the spring noise of the double coil spring is reliably limited.

### (Modifications)

The accelerator pedal apparatuses shown in the above embodiments are only examples for illustrating the embodiments, and therefore they may be an accelerator pedal apparatus employing other configurations. In the above embodiments, the invention is applied to the accelerator pedal apparatus for a vehicle. Alternatively, the invention may be applied to other accelerator pedal apparatuses operated by pedal force. In the above embodiments, the spring apparatus 4 is applied to the accelerator pedal apparatus. However, the spring apparatus 4 is not necessarily applied only to an accelerator pedal apparatus. Thus, the invention may be applied to other spring apparatuses using the double coil spring.

Additional advantages and modifications will readily occur to those skilled in the art. The invention in its broader terms is therefore not limited to the specific details, representative apparatus, and illustrative examples shown and described.

What is claimed is:

1. A spring apparatus comprising:
a double coil spring including an outer coil spring and an inner coil spring; and
an elastically deformable damper made of resin, the damper having at least one ring portion, wherein:
the damper is arranged such that at least a part of the damper is in contact with the outer coil spring and the inner coil spring; and
a spring line of one of the outer coil spring and the inner coil spring passes through the ring portion, so that the ring portion is caught in the one of the outer coil spring and the inner coil spring and the damper is held between the outer coil spring and the inner coil spring.

2. The spring apparatus according to claim 1, wherein the damper is the ring portion.

3. The spring apparatus according to claim 1, wherein the damper has two ring portions formed respectively at both ends of the damper.

4. The spring apparatus according to claim 1, wherein:
the spring apparatus is incorporated in an attachment object;
the double coil spring is attached to the attachment object with the double coil spring compressed; and
a width of the damper in a direction of a central axis of the ring portion is larger than a maximum axial gap, which is the largest gap among axial gaps between adjacent turns of each of the outer coil spring and the inner coil spring in an initial set state of the double coil spring where the double coil spring is attached to the attachment object in a compressed state.

5. An accelerator pedal apparatus comprising:
a supporting member;
an accelerator pedal rotatably supported by the supporting member and depressed by external force; and
a spring apparatus including:
a double coil spring having an outer coil spring and an inner coil spring; and
an elastically deformable damper made of resin, the damper having at least one ring portion, wherein:
the damper is arranged such that at least a part of the damper is in contact with the outer coil spring and the inner coil spring;
a spring line of one of the outer coil spring and the inner coil spring passes through the ring portion, so that the ring portion is caught in the one of the outer coil spring and the inner coil spring and the damper is held between the outer coil spring and the inner coil spring; and
the spring apparatus urging the accelerator pedal in a direction in which the accelerator pedal is returned against the external force.

6. The accelerator pedal apparatus according to claim 5, wherein the damper is the ring portion.

7. The accelerator pedal apparatus according to claim 5, wherein the damper has two ring portions formed respectively at both ends of the damper.

8. The accelerator pedal apparatus according to claim 5, wherein:
the spring apparatus is incorporated in an attachment object;
the double coil spring is attached to the attachment object with the double coil spring compressed; and
a width of the damper in a direction of a central axis of the ring portion is larger than a maximum axial gap, which is the largest gap among axial gaps between adjacent turns of each of the outer coil spring and the inner coil spring in an initial set state of the double coil spring where the double coil spring is attached to the attachment object in a compressed state.
